(19) United States
(12) Patent Application Publication
(10) Pub. No.: US 2009/0042546 A1
(43) Pub. Date: Feb. 12, 2009

(54) Emergency warning system

(76) Inventor: Doyle McClendon, St. Petersburg, FL (US)

Correspondence Address: Epstein & Gerken;Suite 340, 1901 Research Blvd., Rockville, MD, 20850, US

(21) Appl. No.: 11/891,164

(22) Filed: Aug. 9, 2007

(51) Int. Cl. H04M 3/42

(52) U.S. Cl. 455/414.1

(57) ABSTRACT

An emergency warning system for warning members of the public of an emergency situation comprises personal warning devices provided to members of the public and a cellular telecommunication system for transmitting coded cellular burst signals to the personal warning devices to elicit delivery of an emergency warning from the devices. The coded cellular burst warning signals contain emergency situation codes that the personal warning devices parse and translate into an emergency warning message displayed as text on a display screen of the personal warning device.

### BACKGROUND OF THE INVENTION

1. Field of the Invention

The invention pertains generally to devices and systems for warning members of the public of emergency situations. More particularly, the invention involves providing members of the public with personal warning devices to deliver emergency warnings to members of the public who are within the scope of an emergency situation.

2. Brief Discussion of the Related Art

Many types of emergency situations, such as natural and man-made public disasters and catastrophes, can and do arise that expose the general public within the scope of the emergency situation to the risk of harm. Depending on the type and/or severity of the emergency situation, members of the public can be exposed to the risks of physical injury or death and/or damage to property. Many such emergency situations can impact large geographic areas and/or densely populated areas such that a great many individuals are placed at risk of being adversely affected by the emergency situation. Providing members of the public who are at risk with a timely warning of an emergency situation is important in order to avoid panic and mass hysteria, to maintain public order and calm, to provide the individuals with sufficient time to take precautionary measures to protect themselves and/or their property, and/or to enable the individuals to follow any instructions or recommendations issued by authorities.

Presently available systems and devices for delivering emergency warnings to individuals have numerous disadvantages, especially in the context of public use where many individuals must be warned of an emergency situation. Radio and television broadcasting systems cannot be entirely relied on to provide members of the public with emergency warnings because such systems may be rendered inoperable as a result of the emergency situation and/or because individuals may not be listening to a radio or watching a television at the very time that the emergency warning is broadcast. Accordingly, emergency warnings broadcast via radio and/or television may not reach a large segment of the populace for whom the emergency warnings are intended or may not reach individuals until it is too late for them to take protective action. Use of the Internet to deliver emergency warnings has drawbacks like those of radio and television broadcasting, but is even more problematic due to the fact that fewer people own or have access to computers than own or have access to radios and televisions. Moreover, emergency warning systems that communicate via IP addresses are complex, burdensome and generally unfeasable for wide scale public use. Cellular or mobile phones also cannot reasonably be depended on to provide members of the public with timely emergency warnings since not everyone has a cellular phone, and individuals who do have cellular phones oftentimes have them turned off and/or not in their immediate possession at various times throughout the day. In addition, emergency warning systems based on cellular or mobile phones are untenable due to the burden and complexity arising from the many different phone numbers associated with the great number of phones that would need to be called. Sirens are not an adequate mode of communicating emergency warnings because they may be inaudible under many circumstances, their sound may carry over only a relatively small geographic area, and/or the emergency situation may create conditions that prevent them from being activated. Also, sirens cannot communicate information concerning the details of the emergency situation and/or of any recommended course of action issued by authorities.

U.S. Pat. No. 6,112,075 to Weiser proposes an emergency warning system that uses the existing cellular communication network to communicate emergency warnings to warning devices located in a selected geographic area within the geographic region served by the cellular communication network. Persons within the selected geographic area are provided with the warning devices, which generate emergency warnings in response to a predetermined signal transmitted from one of the signal transmission stations in the cellular communication network. The emergency warning is thus selectively transmitted to those warning devices within a certain proximity to the selected transmission station. Weiser alludes to the possibility of having the warning device generate different emergency warnings in response to different preselected signals, but in the example provided by Weiser the different warnings actually pertain to different degrees of severity for the same type of emergency. Weiser does not provide any technical disclosure as to how the warning device could or would be designed to warn of different types of emergencies. Presumably, a separate warning device would be needed for each type of emergency since there is no provision in Weiser to parse the signal at the warning device, and there is no provision for a visual display screen to describe the emergency. Weiser further proposes that the warning devices would be implemented through their SIM codes, which poses the same problem of multiple phone numbers as in the case of cellular telephones. Also, the warning devices plug into conventional AC electrical power wall outlets and therefore are essentially permanent fixtures, with a DC battery being included only as back-up for power failures. Weiser also contemplates installation of the warning devices in vehicles but, again, as essentially permanent fixtures in the vehicles. As stated earlier, the information capable of being communicated by the warning devices is limited due to the fact that the warning devices do not have a visual display suitable for text messages.

Emergency warning systems and devices that rely primarily on cellular or mobile phones are represented by U.S. Pat. No. 6,724,861 to Newland et al, U.S. Pat. No. 6,745,021 to Stevens, U.S. Pat. No. 7,039,386 to Kolsrud, U.S. Pat. No. 7,084,775 to Smith and U.S. Pat. No. 7,174,150 to Shida, by U.S. Patent Application Publication No. 2006/0267783, and by the English abstract of Korean Patent No. 2005062309 A. The system disclosed by Newland et al involves calling the telephone numbers assigned to the cellular phones of the individuals who are to receive the warning. Stevens describes a system where mobile telephone subscribers are notified of emergency conditions based on cell locations. The system requires a controller for receiving emergency information and for initiating emergency notification messages to the mobile phones of the subscribers. Kolsrud pertains to an emergency warning system that utilizes an existing cellular network having base stations serving mobile phones. The base stations send audible emergency information signals to the mobile phones representative of an emergency message. The emergency information signals increase in tone or volume based on the severity of the emergency. Shida pertains to a technique for confirming the safety of individuals possibly affected by a disaster involving communications via the Internet and transmission of disaster notices to the individuals' cell phones. The primary focus of Shida involves receiving information concerning the position of the individuals' cell phones or receiving a voluntary safety confirmation from the individuals' cell phones to judge whether the individuals are safe. The Smith patent and published patent application disclose weather alert systems utilizing mobile or cellular communication services to supply weather alerts to mobile devices, especially mobile phones. Mobile phone users retrieve information on current or impending weather based on the location of their mobile phone. The English abstract of the Korean patent describes an emergency alarm system that uses the Global Positioning System (GPS) of a cellular phone.

### SUMMARY OF THE INVENTION

The present invention is generally characterized in an emergency warning system for warning members of the public of an emergency situation. The emergency warning system comprises personal warning devices provided to members of the public and a cellular telecommunication system for transmitting coded warning signals to the personal warning devices to elicit delivery of an emergency warning from the personal warning devices. The cellular telecommunication system is one that utilizes GSM methodology and has a dedicated channel for transmitting the warning signals to the personal warning devices, such that the coded warning signals are transmitted to the personal warning devices along the dedicated channel as coded cellular burst warning signals. The coded cellular burst warning signals contain a three-digit emergency situation code that corresponds to the particular emergency situation necessitating the emergency warning. The personal warning devices parse the emergency situation code from the warning signal and translate the emergency situation code into a warning message that corresponds to the emergency situation code and, therefore, to the particular emergency situation being warned of. The personal warning devices deliver an emergency warning including the warning message which is displayed as text on a display screen of the personal warning device. The personal warning devices are pre-programmed to process different three-digit emergency situation codes corresponding to different warning messages, such that a single personal warning device can deliver many different warning messages including warning messages pertaining to different types of emergency situations as well as warning messages including different information for a particular emergency situation. Preferably, the different three-digit emergency situation codes all begin with the same digit. The warning messages can contain various types of information and description including the identity or description of the emergency situation by type, location of the emergency situation, instructions or recommendations issued by a public authority to be followed in response to the emergency situation, and/or current conditions or current status of the emergency situation.

The coded cellular burst warning signals may contain a security code that the personal warning devices parse from the warning signals and verify for authenticity prior to delivering the emergency warning. The emergency warning delivered by the personal warning devices may include an audible component, such as an audible alarm that emits sound in conjunction with display of the warning message on the display screen. The emergency warning delivered by the personal warning devices may further comprise a visual alert such as a light indicator on the personal warning devices that is triggered to flash in conjunction with display of the warning message on the display screen.

Various features, advantages and benefits of the invention will become apparent from the following description of the preferred embodiment taken in conjunction with the accompanying drawings.

### BRIEF DESCRIPTION OF THE DRAWINGS

FIG. 1 is a diagram illustrating the emergency warning system, its method of operation, and one of the personal warning devices of the emergency warning system displaying a warning message identifying the type of emergency situation.

FIG. 2 is a diagram representing a cellular telecommunication system used in the emergency warning system.

FIG. 3 is a diagrammatic illustration of the primary operational components of the personal warning device of FIG. 1.

FIG. 4 depicts the personal warning device of FIG. 1 displaying an alternative warning message identifying the location of the emergency situation and containing instructions issued by authorities.

FIG. 5 depicts the personal warning device of FIG. 1 displaying a further alternative warning message identifying current conditions or status of the emergency situation.

FIG. 6 is a diagram depicting the electronic design of the personal warning devices of the emergency warning system.

### DETAILED DESCRIPTION OF THE PREFERRED EMBODIMENT

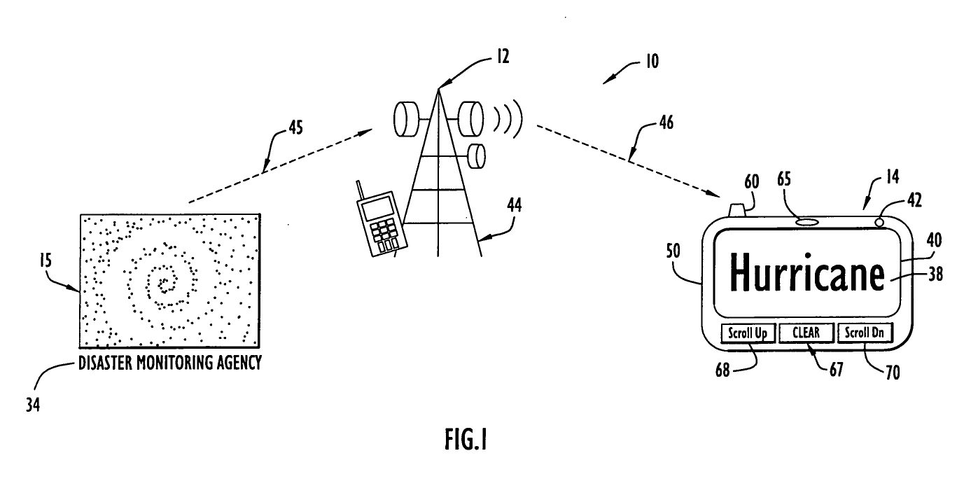

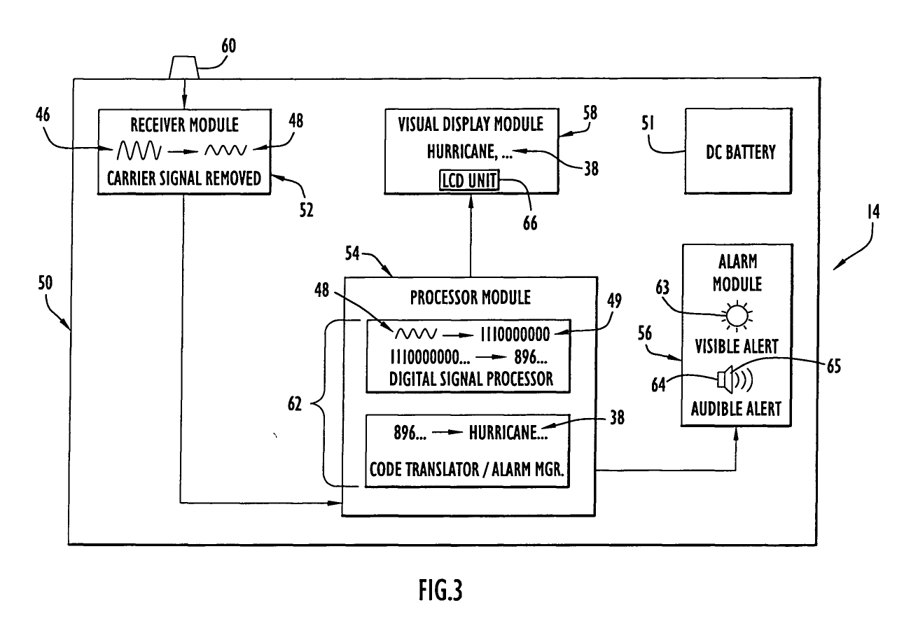

The emergency warning system 10 of the present invention is depicted in general in FIG. 1 and comprises a cellular telecommunication system 12 and personal warning devices 14 that are provided to members of the public. For the sake of simplicity, only one personal warning device 14 is shown in FIG. 1. The personal warning devices 14 are further depicted by FIGS. 3-6 and are described further herein below. The cellular telecommunication system 12 is an existing cellular telephone network with “burst” technology and is utilized in the emergency warning system 10 to communicate emergency warning signals to the personal warning devices 14 which are carried or worn by individuals or otherwise retained in close proximity to the person. The emergency warning system 10 is particularly advantageous for widespread public use to provide timely emergency warnings to individuals at risk of being adversely impacted by an emergency situation, represented at 15 in FIG. 1. The personal warning devices 14 are programmable so that various different codes may be stored therein to provide emergency warnings for many various types of emergency situations including tornadoes, storms such as hurricanes, which is the emergency situation represented at 15 in FIG. 1 as an example, snowstorms and ice storms, flooding, tsunamis, mudslides, terrorist attacks and other types of criminal activities, nuclear accidents, hazardous or toxic substance releases such as chemical spills and releases of biological contaminants, public infrastructure failures such as bridge and tunnel collapses, fires, explosions, and seismic events. The emergency warning system 10 can provide emergency warnings for actual, impending or predicted emergency situations. Emergency warnings can be provided by the emergency warning system 10 to reach affected members of the public in as timely a manner as possible, giving the individuals sufficient time to take precautionary measures to protect themselves and/or their property, giving the individuals the information they need in order to follow instructions issued by public authorities and/or giving the individuals the peace of mind that comes with knowing what has occurred or what may or is about to occur. The emergency warning system 10 can thusly operate in concert with the decision making of local, regional and/or national governing officials or authorities who determine the need and timing for the delivery of the emergency warnings and the content of the emergency warnings.

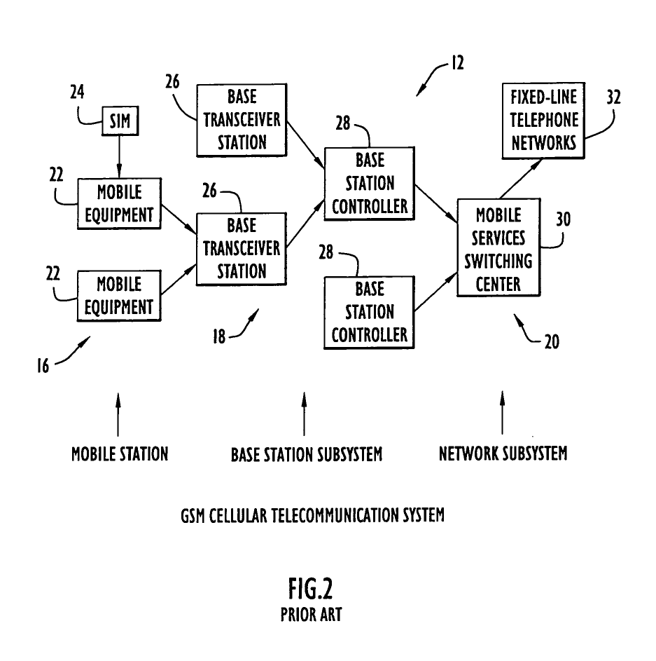

The emergency warning system 10 is implemented using the existing wireless or cellular telecommunication system or network 12, but does not involve the use of cellular or mobile telephones. As depicted in FIG. 2, the existing cellular telecommunication system 12 is based on Global System for Mobile Communications (GSM) technology as currently known in the field of cellular telephone communication networks. GSM is a globally accepted technology or standard for digital cellular telephone communication initiated by Groupe Special Mobile, a pan-European collaboration also commonly referred to as GSM. As discussed further herein in the description of the telecommunication system 12, GSM is intended to refer to the technology or standard known as Global System for Mobile Communications, as opposed to the collaborative entity or group that initiated development of the technology or standard.

GSM was initiated with the objective of creating a common European mobile telephone standard that would enable mobile roaming between member countries. Among the three currently available digital wireless telephone technologies, i.e. GSM, Code Division Multiple Access (CDMA), and Time Division Multiple Access (TDMA), GSM is presently the most popular and most widely used. GSM technology/methodology is implemented throughout the United States by AT&T Mobile (formerly Cingular) on all systems. As of June 2002, about sixty nine percent of all digital mobile subscriptions in the world used GSM phones on GSM networks and, as of March 2003, GSM digital wireless services were offered in some form in over 193 countries. More recent statistics show that GSM services are used by over two billion people across 212 countries and territories.

Since the radio spectrum is a limited resource that must be shared by all users, GSM was devised with a methodology to divide up the radio frequency bandwidth among as many users as possible. The methodology adopted in GSM is known as Time and Frequency Division Multiple Access (TDMA/FDMA), which is basically a combination of Time Division Multiple Access (TDMA) and Frequency Division Multiple Access (FDMA) as explained further below. GSM systems provide signaling and speech channels that are both digital quality, and are considered second generation (2G) mobile phone systems.

As seen in FIG. 2, the standard GSM wireless or cellular telephone telecommunication system or network 12 comprises mobile station 16, a base station subsystem 18 and a network subsystem 20. The mobile station 16 comprises a number of mobile devices 22, such as mobile telephones or other mobile devices equipped with a Subscriber Identity Module (SIM) 24. The SIM 24, also known as a SIM card, is a detachable “smart” card containing the subscriber information and phone book for the user of the mobile device 22. The mobile devices 22 communicate with a base transreceiver station 26 of the base station subsystem 18. The base station subsystem 18 comprises a number of base transreceiver stations 26 and a number of base station controllers 28. As shown in FIG. 2, the base transreceiver stations 26 communicate with a base station controller 28. The base station controllers 28 in turn communicate with a mobile services switching center 30 of the network subsystem 20. The mobile services switching center 30 communicates with a number of fixed-line telephone networks 32.

Radio-related functions are performed in the base station subsystem 18. The base transreceiver stations 26 handle the radio interface to the mobile devices 22. The typical base transreceiver station 26 comprises the necessary radio equipment, i.e. transreceivers and antennae, to service each cell in the network 12. A group of base transreceiver stations 26 are controlled by a base station controller 28. The base station controllers 28 provide the control functions and physical link between the mobile services switching center 30 and the base transreceiver stations 26. The typical base station controller 28 comprises a high-capacity switch that provides functions such as handover, cell configuration data, and control of radio frequency (RF) power levels in the base transreceiver stations 26. A number of base station controllers 28 are served by the mobile services switching center 30. The network subsystem 20 is responsible for performing call processing and subscriber-related functions. The mobile services switching center 30 performs the telephonic switching functions of the system and controls calls to and from other telephone and data systems. The mobile services switching center 30 also performs functions such as toll ticketing, network interfacing, and common channel signaling.

GSM is a cellular network, such that the mobile devices 22 connect to the network by searching for cells in the immediate vicinity. GSM digitizes and compresses voice data, then sends it down a channel with two other streams of user data, each in its own time slot. GSM networks normally operate at either the 900 MHz, 1800 MHz, or 1900 MHz frequency bands. The maximum bandwidth for the uplink and downlink frequency bands is 25 MHz. In the 900 MHz frequency band, for example, the uplink frequency band is 890-915 MHz (25 MHz maximum bandwidth), and the downlink frequency band is 935-960 MHz (25 MHz maximum bandwidth). The FDMA aspect of the TDMA/FDMA methodology used in the GSM cellular telecommunication system 12 involves dividing the maximum 25 MHz frequency bandwidth into 124 carrier frequencies, also called carrier frequency channels, spaced 200 kHz apart. One or more carrier frequencies are assigned to each base transreceiver station 26. The TDMA aspect of the TDMA/FDMA methodology involves dividing each of the carrier frequencies in time. Time division multiplexing is employed to allow 8 full-rate or 16 half-rate speech channels per carrier frequency. The fundamental unit of time in the TDMA methodology is called a “burst period” and it lasts 15/26 milliseconds (ms), or approximately 0.577 ms. There are eight radio timeslots, giving eight burst periods, grouped into what is called a “TDMA frame” having a duration of 120/26 ms, or approximately 4.615 ms, which forms the basic unit for the definition of logical channels. One physical channel is one burst period per TDMA frame. The channel data rate is 270.833 kbit/s. Half-rate channels use alternate frames in the same timeslot. Channels are defined by the number and position of their corresponding burst periods. Channel definitions are cyclical, and the channel definition pattern repeats itself approximately every three hours. Channels can be divided into dedicated channels, which are allocated to a mobile station 16, and common channels which are used by mobile stations in idle mode.

As used in the emergency warning system 10, the GSM cellular telecommunication system 12 sets aside a special, standardized, dedicated channel and transmits coded “burst” warning signals on the dedicated channel to the personal warning devices 14, which then parse the coded warning signals as explained further below. Since the Subscriber Information Module (SIM) 24 is the “gatekeeper” for all GSM systems, all protocols for the emergency warning system 10 are installed therein in order to expedite processing and to obviate the need for standard cellular telephone protocols. Accordingly, the emergency warning system 10 is able to operate within an existing cellular system infrastructure and can thusly be put in use more rapidly and with greater economy by relying on currently available infrastructure and technology. Implementation of the emergency warning system 10 would only require that existing cellular communication services providers or companies cooperate by automatically transmitting coded warning signals via their GSM system to the personal warning devices 14 located in the area of an emergency situation in the transmission area of the GSM system. The personal warning devices 14 can operate in conjunction with any established GSM system in the world. As explained in greater detail herein below, the coded warning signal transmitted via the GSM cellular telecommunication system 12 to the personal warning devices 14 on the set-aside or dedicated cellular channel includes a security code and a three-digit emergency situation code. The personal warning devices 14 extract the security code from the warning signal and use it to confirm the authenticity of the signal, thereby deterring hoaxes and pranks. The personal warning devices 14 extract the emergency situation code from the warning signal and translate the emergency situation code into a warning message that is displayed on the personal warning devices as described further below.

The emergency warning system 10 accommodates transmission of many different three-digit emergency situation codes, which the personal warning devices 14 are programmed to store and process, and preferably all of the emergency situation codes will begin with the same digit, such as “8”. In particular, the emergency warning system 10 can accommodate up to 900 different three-digit emergency situation codes, and up to 100 different three-digit emergency situation codes if each emergency situation code begins with the same digit, i.e. “8”. The emergency warning system 10 is greatly simplified due to the fact that a standard three-digit code is used to activate all of the personal warning devices 14 designated for a particular emergency warning, as opposed to the complex SIM codes normally needed to activate individual cellular telephones.

As best understood from FIG. 1, the emergency warning system 10 is activated when the cellular telecommunication system 12 receives the appropriate codes associated with an emergency situation 15 from an informative source 34, most typically a public authority such as a governmental official or agency in charge of monitoring public emergency situations. Transmission of the codes from the source 34 to the system 12 is represented at 45 in FIG. 1. The public authority will typically transmit or provide the codes to the appropriate cellular communication services provider/providers or company/companies whose system(s) 12 needs to be used to transmit to the personal warning devices 14 of the intended recipients of an emergency warning, and this transmission could be an automated or non-automated transmission. Upon receiving the appropriate codes, the cellular telecommunication system 12 would automatically transmit a coded cellular burst warning signal 46 to the personal warning devices 14 located in the area or areas designated to receive an emergency warning within the transmission area of the system 12. Transmission of the coded warning signal 46 by the cellular telecommunication system 12 to the personal warning devices 14 is accomplished using the burst transmission methodology as employed in the GSM systems as discussed above. As such, the coded warning signal 46 comprises a carrier signal component and an emergency warning signal component 48, which is illustrated in FIG. 3. The security code and emergency situation code are contained in the emergency warning signal component 48. The coded warning signal 46 is operated on by the personal warning device 14 to obtain the security and emergency situation codes as explained below in further detail.

It should be appreciated that the appropriate codes for an emergency situation can be transmitted or supplied to the cellular telecommunication system 12 in various ways and circumstances. For example, codes can be transmitted or supplied to the cellular telecommunication system 12 from a governmental agency, such as the Department of Homeland Security, for transmission to the personal warning devices 14 located in an area identified as being at risk for a possible terrorist threat. As another example, codes can be transmitted to the telecommunication system 12 via satellite by a governmental agency, such as the National Oceanic and Atmospheric Agency (NOM) or the National Weather Service, to designated areas within the U.S. and/or to selected countries and city codes outside of the U.S., in the case of a weather-related emergency situation such as a tsunami alert. As a further example, codes can be transmitted to the telecommunication system 12 by an observer or witness to an emergency situation dialing the three-digit emergency situation code on a cellular or mobile telephone or on a telephone connected to a land line. To ensure the authenticity or veracity of the transmission, the security code would need to have been earlier transmitted to the telecommunication system 12 by a suitable public authority in anticipation of the emergency situation in the observer's area. For anyone within the range of the cellular telecommunication system 12, no cellular tower would be needed, such that the emergency warning system 10 would be essentially storm-proof for local emergency situations. Allowing emergency situations to be reported by observers dialing an emergency situation code can be effectuated through national or governmental designation or adoption of the digit “8”, i.e. the first digit in all of the emergency situation codes, for public emergency notification in much the same manner as the digit “9” has heretofore been generally designated for emergencies. As an additional example, codes associated with an emergency situation, such as an intruder in a school, can be transmitted by local authorities, such as by dialing the appropriate code, to effectuate transmission of a warning signal to the personal warning devices of the students at or in the vicinity of the school. The emergency warning system 10 operates to deliver emergency warnings in a rapid timely manner. If implemented universally, the emergency warning system 10 would immediately warn other nearby individuals of an impending emergency situation with a touch of the “8” button.

When a personal warning device 14 extracts or parses an emergency situation code from the coded warning signal 46 transmitted to it on the dedicated channel of the cellular telecommunication system or network 12, the personal warning device 14 will deliver an emergency warning composed of audible and visual components. The audible component of the emergency warning constitutes an audible alarm, preferably a loud, wailing tone. The visual component of the emergency warning preferably comprises a text emergency warning message 38 displayed on a display screen 40 of the personal warning device and a flashing warning light indicator 42 providing a visual alert. It should be appreciated that the personal warning device 14 could be designed to deliver an emergency warning having a tactile component such as a vibration. The personal warning devices 14 are described in further detail herein below.

In the example depicted in FIG. 1, the informative source 34 that supplies an emergency situation code to the appropriate system 12 is depicted as a natural disaster monitoring agency. The emergency situation 15 being monitored is depicted as a hurricane. The informative source 34 transmits a security code and an emergency situation code to cellular towers 44 within a GSM telecommunication system 12 that serves the personal warning devices 14 located in the area designated to receive a warning of the hurricane. The emergency situation code, indicated by way of example as “896” in FIG. 3, is one that is predetermined in the emergency warning system 10 to correspond to an emergency warning for a hurricane, and the personal warning devices 14 have been pre-programmed to contain this code in storage and to process this code into an emergency warning for a hurricane. The cellular towers 44 automatically transmit the security and emergency situation codes in a coded cellular burst warning signal 46 along the dedicated channel of the system 12 to the personal warning devices 14 within the area designated to receive the emergency warning. For emergency situations outside of the United States, but known to a U.S. public authority, warnings and codes may be transmitted by the U.S. public authority to a local authority in the area of the emergency situation, and then transmitted by the local authority to the local GSM system. Conversely, public authorities outside the U.S. can transmit warnings and/or codes to U.S. public authorities for emergency situations affecting the U.S.

Each personal warning device 14 operates on the coded warning signal 46 to obtain the security code and the emergency situation code. The personal warning device 14 confirms the validity of the security code to ensure authenticity of the signal, and translates the three-digit emergency situation code into a text emergency warning message 38 that corresponds to the three-digit emergency situation code. The personal warning device 14 then proceeds to deliver the emergency warning, which includes the text warning message 38 that is appropriate for the specific emergency situation, i.e. hurricane. The audible component of the emergency warning can be the same for all types of emergency situations. However, it should be appreciated that different audible alarm sounds can be emitted by the personal warning devices 14 for different emergency situations. The warning light indicator 42 can be the same for all types of emergency situations but, again, different flashing patterns, different colored lights and/or different indicators can be used for different emergency situations.

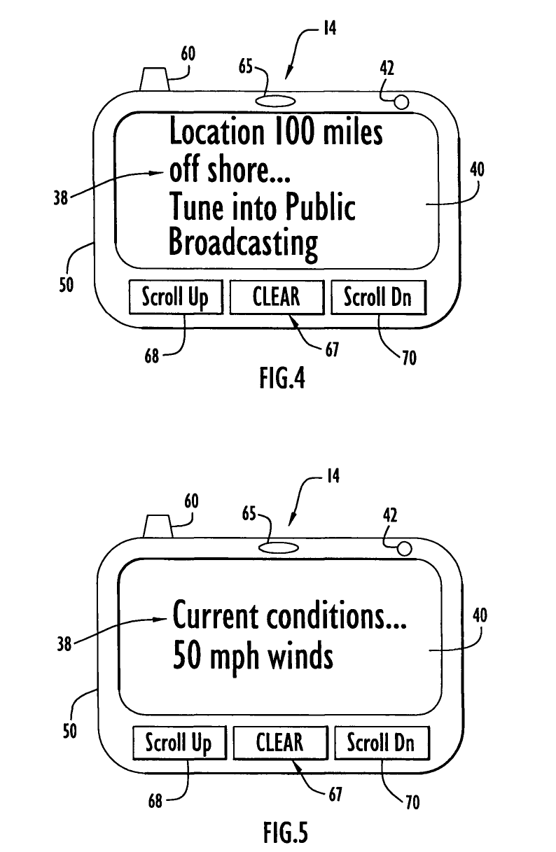

The content of the text emergency warning message 38 that appears on the display screen 40 of the personal warning device 14 will vary depending on the emergency situation code, in that each emergency situation code available for use in the emergency warning system 10 corresponds to a different text emergency warning message. Since the emergency warning system 10 accommodates a great many different emergency situation codes, each personal warning device 14 is capable of displaying a great many different text messages. The emergency situation code that is supplied to the telecommunication system 12 for retransmission to the personal warning devices 14 in a given emergency situation can thusly be selected based on the need to communicate to the public the particular text warning message that corresponds to that emergency situation code. The text warning message will preferably identify or describe the type of emergency situation being warned of. For example, the text message 38 in FIG. 1, which corresponds to the three-digit emergency situation code “896”, contains the word “Hurricane” to describe or identify the type of emergency situation 15 being warned of. The text message 38 depicted in FIG. 4 is an example of one that identifies the location of the emergency situation (e.g. “Location 100 miles off-shore”) as well as instructions issued by a public authority (e.g. “Tune into Public Broadcasting”). The text message 38 depicted by way of example in FIG. 5 contains information pertaining to current conditions or status of the emergency situation (e.g. “Current conditions . . . 50 mph winds”). It should be appreciated that different types of information, including type of emergency situation, location of emergency situation, instructions or recommendations to be followed, and current conditions or status of the emergency situation, can be contained in a single text warning message or in different text warning messages.

The personal warning devices 14, as best understood with reference to FIGS. 1, 3 and 6, are of compact, miniature design and preferably are small enough to be carried and/or worn by the user or otherwise retained in close proximity to the user. The physical dimensions of the housing 50 of the personal warning device 14 are most preferably small enough in size to allow the personal warning device 14 to be attached to a keychain, attached to a loop worn around the neck of the user, to fit within a pocket of the user's clothing and/or to be suspended on a small hook attachable to a belt loop or any other suitable structure carried by, worn by or in close proximity to the user. The personal warning devices 14 are completely portable, each being powered by a DC battery 51 in housing 50. The personal warning devices 14 are in a continuous “ON” state and cannot be turned off. The personal warning devices 14 are in an “idle on” mode when not delivering an emergency warning.

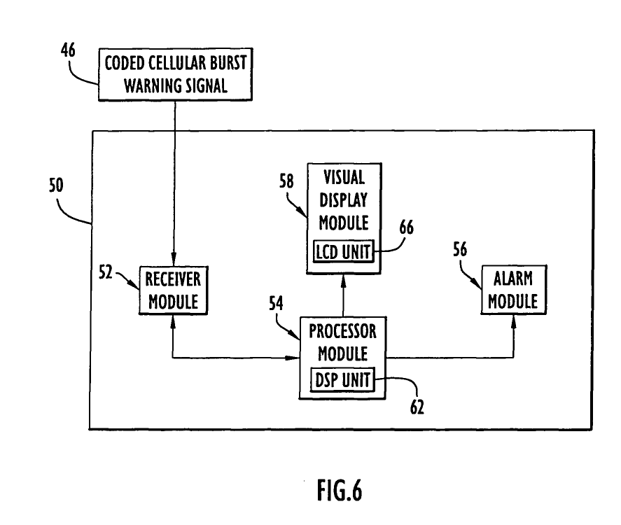

As shown in FIGS. 3 and 6, each personal warning device 14 comprises a receiver module 52, a processor module 54, an alarm module 56 and a visual display module 58. The receiver module 52 receives the coded cellular burst warning signal 46 transmitted by the GSM telecommunication system 12. The coded warning signal 46 received by the receiver module 52 comprises the carrier signal component and the emergency warning signal component 48. The coded cellular burst warning signal 46 is received by the receiver module 52 in analog form through an antenna 60, shown in FIG. 1, of the receiver module 52. The receiver module 52 operates on the warning signal 46 to remove or separate the carrier signal component therefrom and extract the underlying emergency warning signal component 48 as depicted in FIG. 3. The receiver module 52 includes the electronics needed to operate on the warning signal 46 so that the emergency warning signal component 48 is extracted therefrom. The receiver module 52 also includes the electronics needed to perform rudimentary transmissions establishing “hand shaking” communications with local cell towers and cellular locating systems. The processor module 54 receives the extracted emergency warning signal component 48 from the receiver module 52 and processes the extracted emergency warning signal component 48 through a digital signal processor (DSP) unit 62 of the processor module 54. The DSP unit 62 converts the analog emergency warning signal component 48 into a digital emergency warning signal component 49 as seen in FIG. 3, and is programmed to extract or parse the security code and the three-digit emergency situation code from the digital emergency warning signal component 49. For the sake of simplicity, only the emergency situation code, i.e. “896”, is shown extracted or parsed from the digital signal component 49 in FIG. 3; however, it should be appreciated that the security code is also extracted or parsed in the same manner from the digital signal component 49. After extracting and confirming the authenticity of the security code, the DSP unit 62 operates to translate the emergency situation code into the warning message 38 that corresponds to the emergency situation code as seen in FIG. 3. The processor module 54 sends triggering commands to the alarm module 56 and to the visual display 58 module to effect delivery of the emergency warning from the personal warning device 14.

The alarm module 56 comprises a flashing light emitting diode (LED) 63 for the warning light indicator 42 and an audible alarm 64 with a speaker 65 for emitting the sound that provides the audible component of the emergency warning. When the alarm module 56 is triggered by the processor module 54, the LED 63 will flash, preferably red in color, at the warning light indicator 42, which is located on the housing 50 to provide the user of the personal warning device with a visual alert. The audible alarm 64 preferably emits a loud, wailing tone through the speaker 65, which may be disposed along the housing 50 as seen in FIG. 1, in response to triggering of the alarm module 56 by the processor module 54. The visual display module 58 comprises the display screen 40, which is located on the housing 50, and a liquid crystal diode (LCD) unit 66 that displays the text warning messages on the display screen 40. The LCD unit 66 is a compact, low-power, multi-line LCD unit providing a digital visual display. The personal warning devices 14 can be designed simply and inexpensively using standard electrical components, circuit design and programming, making it economically feasible to make them available for widespread or universal public use.

The personal warning device 14 can be designed to deliver the emergency warning for a pre-set period of time, for example two minutes, before automatically re-setting itself to the idle mode. Alternatively or in addition to an automatic re-set function, the personal warning device 14 can be designed with a manual re-set function, allowing the user to manually re-set the personal warning device to the idle mode. As shown in FIG. 1, the personal warning device 14 can include a manual re-set 67, such as a “CLEAR” button, on the housing 50 for the user to manually engage in order to clear the emergency warning and re-set the personal warning device to the idle mode. It should also be appreciated that delivery of the emergency warning from the personal warning device 14 can continue until another coded warning signal is transmitted to the personal warning device containing a re-set code, which code will be translated by the DSP unit 62 into a re-set command that re-sets the personal warning device to the idle mode. It should also be appreciated that the emergency warning being delivered from the personal warning device 14 can be modified by a subsequently transmitted coded warning signal containing a emergency situation code that translates to a different warning message. The LED 63 can be designed to flash and/or light in a green color to indicate clearance of an emergency warning and/or to provide an indication of adequate battery power.

Because the personal warning device 14 is small in size, the amount of text that can be displayed on the display screen 40 is limited by the size of the display screen. Accordingly, it is advantageous for the visual display module 58 of the personal warning device 14 to include a scroll function, permitting up and down scrolling of the text messages displayed on the display screen 40. As seen in FIG. 1, the scroll function can be effectuated through the use of manually operable up and down scroll buttons 68 and 70 on housing 50, the scroll button 68 being operable to allow the text warning message to be scrolled up and the scroll button 70 being operable to allow the text warning message to be scrolled down.

The personal warning devices 14 can be designed uniformly to process the same three-digit emergency situation codes into the same corresponding text warning messages, in which case the personal warning devices 14 can be designed to deliver text warning messages suitable for many types of emergency situations. However, it should be appreciated that the personal warning devices 14 could be risk-specific in design in that personal warning devices used in areas at negligible or no risk of a certain type of emergency situation need not be designed to deliver text warning messages pertaining to that type of emergency situation. In this case, the three-digit emergency situation codes not needed for warning messages pertaining to the inapplicable type of emergency situation can be used in the personal warning devices to deliver other emergency warning messages merely by modifying the programming of and processing functions performed by the processor module.

Inasmuch as the present invention is subject to many variations, modifications and changes in detail, it is intended that all subject matter discussed above or shown in the accompanying drawings be interpreted as illustrative only and not be taken in a limiting sense.

What is claimed is:

1. An emergency warning system for warning members of the public of an emergency situation, comprising
personal warning devices provided to members of the public; and
a cellular telecommunication system having a dedicated channel for transmitting a three-digit emergency situation code corresponding to an emergency situation as a coded cellular burst warning signal to said personal warning devices;
said personal warning devices being responsive to receipt of said coded cellular burst warning signal to parse said emergency situation code from said signal, to translate said emergency situation code into a warning message pertaining to the emergency situation, and to display said warning message as text on a display screen of said personal warning device.

2. The emergency warning system recited in claim 1 wherein said telecommunication system transmits a security code along with said emergency situation code in said coded cellular burst warning signal, and said personal warning devices are responsive to receipt of said coded cellular burst warning signal to parse said security code from said signal and to confirm the authenticity of said security code before displaying said warning message.

3. The emergency warning system recited in claim 2 wherein said telecommunication system is capable of transmitting different three-digit emergency situation codes as coded cellular burst warning signals to said personal warning devices, and said personal warning devices are capable of parsing said different emergency situation codes from said signals, of translating said different emergency situation codes into different warning messages, and of displaying said different warning messages on said display screen.

4. The emergency warning system recited in claim 3 wherein said different emergency situation codes correspond to different types of emergency situations.

5. The emergency warning system recited in claim 4 wherein said warning message contains information pertaining to the type of emergency situation.

6. The emergency warning system recited in claim 5 wherein said warning message contains information pertaining to the location of the emergency situation.

7. The emergency warning system recited in claim 5 wherein said warning message contains information pertaining to instructions issued by a public authority in response to the emergency situation.

8. The emergency warning system recited in claim 5 wherein said warning message contains information pertaining to the current status of the emergency situation.

9. The emergency warning system recited in claim 4 wherein each of said different emergency situation codes begin with the same digit.

10. The emergency warning system recited in claim 1 wherein said telecommunication system is an established GSM cellular telephone network.

11. The emergency warning system recited in claim 1 wherein said personal warning devices further include an audible alarm and are operable to emit sound from said audible alarm in conjunction with display of said warning message.

12. The emergency warning system recited in claim 1 wherein said personal warning devices further include a warning light indicator and are operable to flash said warning light indicator in conjunction with display of said warning message.

13. An emergency warning system for warning members of the public of an emergency situation, comprising
a cellular telecommunication system having a channel for transmitting an analog coded burst warning signal comprising an emergency warning signal component including a security code and an emergency situation code; and
personal warning devices provided to members of the public in an area served by said telecommunication system, said personal warning devices being portable and sufficiently small in size to be retained in close proximity to a person, each of said personal warning devices comprising a receiver module, a processor module, an audible alarm, and a visual display module including a display screen, said receiver module receiving said analog coded burst warning signal and extracting said emergency warning signal component from said analog coded burst warning signal, said processor module converting said emergency warning signal component to a digital signal, obtaining said security code and said emergency situation code from said digital signal, confirming the authenticity of said security code, translating said emergency situation code into a warning message, and triggering delivery of an emergency warning including an audible warning delivered as sound from said audible alarm and a visual warning including said warning message displayed as text on said display screen.

14. The emergency warning system recited in claim 13 wherein said analog coded burst warning signal comprises a carrier signal component and said emergency warning signal component, said receiver module includes an antenna receiving said analog coded burst warning signal, and said receiver module operates to remove said carrier signal component from said warning signal.

15. The emergency warning system recited in claim 13 wherein said personal warning devices further include a warning light indicator and said visual warning further includes flashing of said warning light indicator.

16. The emergency warning system recited in claim 13 wherein said cellular telecommunication system is capable of transmitting analog coded burst warning signals comprising different emergency warning signal components including different emergency situation codes, said receiver module is capable of extracting said different emergency warning signal components from said warning signals, and said processor module is capable of converting said different emergency warning signal components to digital signals, of obtaining said different emergency situation codes from said digital signals, and of translating said different emergency situation codes into different warning messages.

17. The emergency warning system recited in claim 13 wherein said personal warning devices are in an idle on mode when not delivering an emergency warning, and said personal warning devices automatically re-set themselves to said idle on mode after delivering said emergency warning for a predetermined period of time.

18. The emergency warning system recited in claim 13 wherein said personal warning devices are in an idle on mode when not delivering an emergency warning, and said personal warning devices are manually re-settable to said idle on mode after beginning delivery of said emergency warning.

19. The emergency warning system recited in claim 13 wherein said emergency situation code is supplied to said telecommunication system from a public authority.

20. The emergency warning system recited in claim 13 wherein said security code is supplied to said telecommunication system from a public authority, and said emergency situation code is supplied to said telecommunication system by a member of the public dialing said emergency situation code on a telephone.
